(19) United States
(12) Patent Application Publication
(10) Pub. No.: US 2017/0070187 A1
(43) Pub. Date: Mar. 9, 2017

(54) Solar tracking system and a method thereof

(71) Applicant: MAHINDRA SUSTEN PVT LTD., Mumbai (IN)

(72) Inventors: Apurav Padam Jain, Mumbai (IN); Basant Kumar Jain, Mumbai (IN); Akshay Keshav Roge, Mumbai (IN); Rohit Gupta, Jaipur (IN)

(21) Appl. No.: 15/259,955

(22) Filed: Sep. 8, 2016

(30) Foreign Application Priority Data
Sep. 9, 2015 (IN) 3455/MUM/2015

(51) Int. Cl. H02S 20/32; G01S 3/786

(52) U.S. Cl. CPC H02S 20/32; G01S 3/7861

(57) ABSTRACT

The present disclosure envisages a solar tracking system. The solar tracking system of the present disclosure relates to the field of solar energy. The solar tracking system of the present disclosure has a simple operation and is self-powered and requires less maintenance. The principal use of the solar tracking system of the present disclosure is in solar power plants.

### CROSS-REFERENCE TO RELATED APPLICATIONS

This application claims priority from Indian Patent Application No. 3455/MUM/2015, filed on Sep. 9, 2015, in the Indian Patent Office, the disclosure of which is incorporated herein by reference in its entirety.

### FIELD

The present disclosure relates to the field of solar trackers.

### BACKGROUND

Solar panels are mounted on vertical posts for collecting and converting Sunlight to energy. Typically this arrangement is installed in an area where abundant Sunlight is available. However, as a result of the rotational movement of the earth the direction and alignment of the solar panel with respect to the Sun varies with respect to the time of the day and the day of the year and the latitude and longitude of the place where the solar panel is mounted. The solar panel is required to be angularly displaced during the day to track the apparent movement of the Sun so that the Sun's rays are roughly perpendicular to the surface of the panel for optimally capturing the maximum solar energy in the panel. This requires the use of a tracking mechanism.

A solar tracker is a device that orients a solar panel, mirrors or lenses toward the Sun. Solar trackers are used to optimize the angle of incidence between the incoming Sunlight and a photovoltaic panel, thereby increasing the amount of energy produced from a fixed amount of power generating capacity.

Complex and expensive solar array tracker controlling systems have been suggested which are expensive and require preconfiguring a controller for location specific Sun angles and also need continuous maintenance. Therefore, there is a need for a solar tracking system for controlling the solar tracker which should not be complex, should not require too much relative power for operation, must not require any maintenance and should operate 365 days of the year continuously to track the Sun rays incident on the solar panel.

### OBJECTS

Some of the objects of the present disclosure, which at least one embodiment herein satisfies, are as follows.

It is an object of the present disclosure to ameliorate one or more problems of the prior art or to at least provide a useful alternative.

An object of the present disclosure is to provide a solar tracking system that is not complex.

Another object of the present disclosure is to provide a solar tracking system that is self-powered and requires less maintenance.

Other objects and advantages of the present disclosure will be more apparent from the following description, which is not intended to limit the scope of the present disclosure.

### SUMMARY

The present disclosure envisages a solar tracking system for automatically controlling the tracking of at least one solar panel in a solar array table. The system comprises a weather information unit associated with the at least one solar panel. The weather information unit includes a plurality of sensors configured to sense a plurality of weather parameters and generate a plurality of sensed signals, and a signal conditioning unit configured to receive the plurality of sensed signals and generate a plurality of conditioned signals corresponding to the plurality of sensed signals. A GPS unit is associated with the at least one solar panel. The GPS unit is configured to determine the coordinates of a location of the at least one solar panel and generate position signals. A repository is configured to store at least one pre-determined threshold value associated with the plurality of weather parameters and at least one imperial astronomical formula and trigonometry. A motor driver is associated with each solar panel in the solar array table. The motor driver is configured to drive at least one actuator associated with each solar panel of the solar array table. A shadow computation unit is configured to compute the presence of a shadow, using the imperial astronomical formula and trigonometry, on the solar array table and generate shadow computation signals. A processor is communicatively coupled with the weather information unit, the GPS unit, the repository, the motor driver, and the shadow computation unit. The processor is configured to receive the plurality of conditioned signals, the position signals, and the shadow computation signals and control the tracking of the at least one solar panel via the motor driver based on the plurality of pre-determined threshold values and the at least one imperial astronomical formula and trigonometry.

In an embodiment, the plurality of sensors is selected from the group consisting of a wind sensor, a temperature sensor, a pyrometer, a rainfall sensor, a pressure sensor, and a humidity sensor.

In another embodiment, the type of the plurality of conditioned signals is selected from the group consisting of an analog signal, a digital signal, a mixed signal, a protocol, a frame and a packet.

In an embodiment, the at least one weather parameter of the plurality of weather parameters is wind speed sensed by the wind sensor. The processor is configured to select a conditioned signal from the plurality of conditioned signals corresponding to a sensed signal, from the plurality of sensed signals, generated by the wind sensor. Based on the conditioned signal, the processor is configured to extract a wind speed. The processor is then configured to compare the wind speed value with a pre-determined threshold value from the at least one pre-determined threshold value.

In a first aspect of the aforementioned embodiment, the processor is configured to generate and transmit command signals to the motor driver for orienting the at least one solar panel in a safe position, when the wind speed value is greater than the pre-determined threshold value.

In a second aspect of the aforementioned embodiment, when the wind speed value is less than the pre-determined threshold value, the processor is further configured to receive at least one position co-ordinate signal and at least one global time signal from the GPS unit. The processor is further configured to calculate the solar azimuth and zenith angles of the Sun using the at least one position co-ordinate signal and the at least one global time signal based on the at least one imperial astronomical formula and trigonometry. Subsequent to the sunset, the processor is further configured to generate and transmit backtracking signals to the motor driver, for moving the at least one actuator to orient the at least solar panel at an initial position.

In an embodiment, the system further includes a feedback unit configured to generate and transmit feedback signals pertaining to the movement of the actuator to the processor.

The present disclosure also envisages a solar tracking method for automatically controlling the tracking of at least one solar panel in a solar array table.

### BRIEF DESCRIPTION OF ACCOMPANYING DRAWING

A solar tracking system of the present disclosure will now be described with the help of accompanying drawing, in which:

FIG. 1 illustrates a block diagram of the solar tracking system, in accordance with an embodiment of the present disclosure; and

FIG. 2 illustrates a method of controlling drive motors operatively connected to solar panels.

### LIST OF REFERENCE NUMERALS USED IN DETAILED DESCRIPTION AND DRAWING

100 Solar Tracking System
102 Processor
104 Motor Driver
106 Control inputs
108 Feedback
110 Feedback Unit
112 Repository
114 Operator Interface
116 GPS Unit
118 Weather Information Unit
120 Internet Interface Unit
122 Battery Backup
124 Shadow computation unit
200 Solar Tracking Method
202 Step of sensing a plurality of weather parameters and generating a plurality of sensed signals
204 Step of receiving the plurality of sensed signals and generating a plurality of conditioned signals corresponding to the plurality of sensed signals
206 Step of determining coordinates of a location of the solar array table and generating position signals
208 Step of storing at least one pre-determined threshold value associated with the plurality of weather parameters and at least one imperial astronomical formula and trigonometry
210 Step of detecting the presence and length of a shadow on the solar array table and generating shadow computation signals
212 Step of receiving the plurality of conditioned signals, position signals, and shadow computation signals
214 Step of controlling the tracking of the at least one solar panel, via a motor driver, based on the plurality of pre-determined threshold values and the at least one imperial astronomical formula and trigonometry

### DETAILED DESCRIPTION

The present disclosure relates to a solar tracking system that utilizes inputs relating to latitude, longitude of the location at which tracker is mounted, and time, and then based on the inputs, employs an imperial astronomical formula and trigonometry to calculate solar azimuth and zenith angles of the Sun, and initiates movement of an actuator, which includes but not limited to hydraulic actuators, pneumatic actuators, DC motors, and the like, to optimally position the solar panel based on the solar azimuth and zenith angles of the Sun. The solar tracking system of the present disclosure is particularly well suited for controlling the positioning of arrays of solar panels in a solar array table. The solar tracking system of the present disclosure is configured to be mounted on a solar tracker, such as that described in co-pending Indian Patent Application Serial Number 3218/MUM/2015, filed 24 Aug. 2015, and entitled “An Arrangement for Tracking of Solar Panels”, which application is incorporated in its entirety by reference herein. The solar tracking system of the present invention is designed to provide control inputs to the motor/actuator which optimally position solar panels. However, the solar tracking system envisaged herein is not restricted to use with arrangement for tracking of solar panels as disclosed in our co-pending application but is applicable to other solar panels which use motors for actuating the tracking.

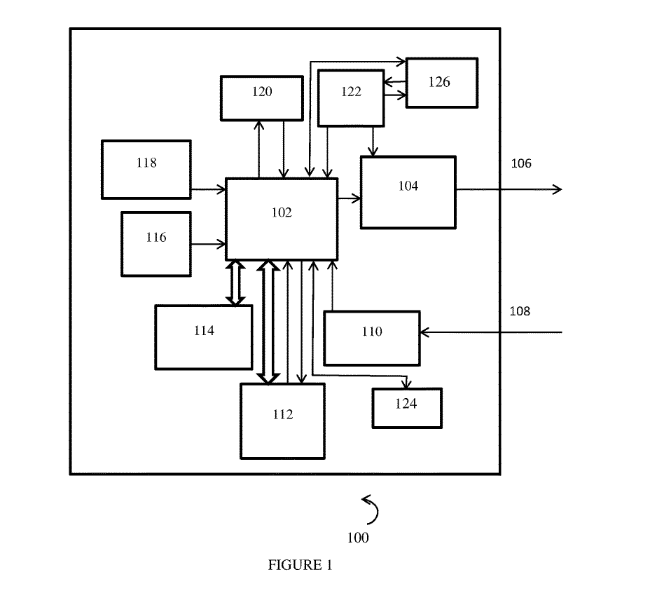

FIG. 1 illustrates a block diagram of the solar tracking system for automatically controlling the tracking of at least one solar panel in a solar array table, in accordance with an embodiment of the present disclosure. The solar tracking system (100) comprises a processor (102), a motor driver (104), a feedback system (110), a data repository (112), an operator interface (114), a GPS unit (116), a weather information unit (118), an internet interface unit (120), a battery backup (122), a shadow computation unit (124), a display (not shown in the figure), a battery management unit (126) and optionally a buzzer (not shown in the figure).

In accordance with an embodiment of the present disclosure, the weather information unit (118) includes a plurality of sensors (not explicitly shown in figures) configured to sense a plurality of weather parameters and generate a plurality of sensed signals. The weather information unit (118) also includes a signal conditioning unit (not explicitly shown in figures) configured to receive the plurality of sensed signals and generate a plurality of conditioned signals corresponding to the plurality of sensed signals. In an embodiment, the plurality of sensors may generate analog or digital signals. The digital signals generated by the plurality of sensors may be directly transmitted to the processor without requiring the signal conditioning unit. Further, the processor may receive the information using any communication protocol. Still further, the processor may receive the information in any format for further processing.

The GPS unit (116) is configured to determine the coordinates of the location of the solar array table and generate position signals. The repository (112) is configured to store at least one pre-determined threshold value associated with the plurality of weather parameters and at least one imperial astronomical formula and trigonometry. The motor driver (104) is configured to drive at least one actuator associated with at least one solar panel of the solar array table. The shadow computation unit (124) is configured to compute a presence of a shadow in a simulated solar array table using the imperial astronomical formula and trigonometry to generate a shadow computation signal. The working of the shadow computation unit (124) has been discussed in the subsequent sections of the present disclosure. The processor (102) is communicatively coupled with the weather information unit (118), the GPS unit (116), the repository (112), the motor driver (104), and the shadow computation unit (124). The processor (102) is configured to receive the plurality of conditioned signals, the position signals, and the shadow computation signals and control the tracking of the at least one solar panel via the motor driver (104) based on the plurality of pre-determined threshold values and the at least one imperial astronomical formula and trigonometry.

The plurality of sensors include a wind sensor, a temperature sensor, a pyrometer, a rain fall sensor, a pressure sensor, a humidity sensor and any other known sensors. In one embodiment, the weather information unit (118) conditions the wind sensor signals to obtain conditioned signals which are received by the processor (102). During potentially damaging high winds, the signal alerts the processor (102) to send control inputs to the drive motors to position the solar panels in a safe position, as described in the subsequent sections of the present disclosure.

In an embodiment, the processor (102) is further configured to select a conditioned signal from the plurality of conditioned signals corresponding to a sensed signal, from the plurality of sensed signals, generated by the wind sensor. Based on the conditioned signal, the processor (102) is configured to extract a wind speed. The processor (102) is then configured to compare the wind speed value with a pre-determined threshold value from the at least one pre-determined threshold value.

On detecting that the wind speed value is greater than the pre-determined threshold value, the processor (102) is configured to compute a safe position signal using the current detected wind speed value. The processor is further configured to transmit the safe position signal to the motor driver (104). The motor driver generates a plurality of drive signals (106) using the safe position signal to drive the motors and actuators for orienting the at least one solar panel in accordance with a plurality of control values present in the safe position signal.

On detecting that the wind speed value is less than the pre-determined threshold value, the processor (102) is further configured to receive at least one position co-ordinate signal and at least one global time signal from the GPS unit (116). The processor (102) is then configured to calculate the solar azimuth and zenith angles of the Sun using the at least one position co-ordinate signal and the at least one global time signal based on the astronomical formula and trigonometry. The shadow computation signals are also received by the processor (102) for calculating a compensation angle in case when a shadow is present. Subsequent to the setting of the Sun, the processor (102) is further configured to generate and transmit backtracking signals to the motor driver (104), for moving the at least one actuator to orient the at least solar panel at an initial position.

In an embodiment, the system (100) further includes the feedback unit (110) that is configured to receive feedback (108) of the positioning of the actuator and then generate and transmit feedback signals pertaining to the movement of the actuator to the processor (102). The feedback unit (110) is further configured to detect any failures in the drive motors and the actuation associated therewith by sensing the current values in the feedback signal. Such a feedback increases the life of the system by facilitating reduced maintenance at optimized cost.

The feedback unit (110) is configured to receive the feedback signals indicating the current position of at least one solar panel from at least one actuator associated with the at least one solar panel. The processor (104) receives the shadow computation signals generated by the shadow computation unit (124) and the feedback signals generated by the feedback unit (110) at every instant of time. The processor (102) compares the feedback signal with the shadow computation signal. On detecting a mismatch between the signal values of the feedback signal and the shadow computation signal, the processor (102) commands to the motor drivers (104) to drive the at least one actuator associated with the at least one solar panel. This is an iterative process. The value of the feedback signal changes in accordance with the drive provided by the motor driver (104) to the at least one actuator. The processor (102) continues to compare the shadow computation signals and the feedback signals at ever instant of time until the values of the shadow computation signal and the feedback signal are same. As such, an absence of mismatch between the shadow computation signals and the feedback signals indicates that the solar panel has been appropriately reoriented in a manner that the shadow is no longer present on the solar panel.

The solar array table includes at least one matrix of solar panels. In an embodiment, if there are N number solar panels in the matrix, then there are N processors (102), N actuators, N GPS units (116), N feedback units (110), and N motor drivers (104) for controlling the operation of each of the solar panels in the matrix. In an alternative embodiment, if there are N solar panels in the matrix, then there are N-2 or N-3 processors (102), N actuators, N feedback units (110), one central GPS unit (116), and N motor drivers (114) for controlling the operation of each of the solar panels in the matrix. More specifically, the number of processors (102) used to control the operation of the solar array table may vary depending upon the configuration of the processors. For example, one central processor may be sufficient to control the entire solar array table or more than one processor may be required to control the entire solar array table.

The at least one matrix of solar panels includes at least one row and at least one column of solar panels. In an embodiment, a central weather information unit (118) may control the operation of entire solar array table. In another embodiment, one weather information unit (118) may control the operation of at least one row of solar panels. In yet another embodiment, more than one weather information unit (118) may be used to control the operation of the solar array table.

The processor (102) may be selected from the group consisting of an ARM processor, a PIC microcontroller, an ASIC processor, a microcontroller, an FPGA processor and a microprocessor. In training phase, the processor (102) is trained using typical imperial astronomical formula and trigonometrye to calculate solar azimuth and zenith angles of the Sun. The processor (102) is then configured to initiate the movement of an actuator to optimally position the solar panel based on the solar azimuth and zenith angles of the Sun. The processor (102) may send a command signal to the motor driver (104), and the motor driver (104) may send pulses to control the drive motors. The duty cycle of the pulses generated by the motor driver (104) changes every day based on an angle of the Sun. It is to be noted that the duty cycle changes according to the speed of the Sun rotation with respect to the stationary point on Earth where the solar tracking system is installed.

The GPS unit (116) generates position signals to provide highly accurate information on co-ordinates of the location of the solar array table and global time to the processor (102) based on the installation of solar panel at particular location. The internet interface unit (120) is coupled with the processor (102) and allows remote acquisition and transmission of data and status of the various elements of the system (100) via a global computer network, such as the Internet, or in a wide area network or a local area network.

In another embodiment, the weather information unit (118) conditions the rainfall sensor signals to obtain conditioned signals which are received by the processor (102). During raining, the conditioned rainfall sensor signal alerts the processor (102) to send control signals to the drive motors to position the solar panels at safe angle to ensure proper drainage of water from the solar panels. The drainage of the water from the solar panels also helps in cleaning of the solar panels.

In one embodiment, the motor driver (104) drives the drive motors in discrete steps. The motor driver (104) is configured to drive at least one actuator associated with at least one solar panel of the solar array table. Typically, the ratio of step period to hold period is 1:4. The motor driver (104) generates periodic pulses to drive the drive motors. At the end of the day at sunset, when solar intensity falls below the threshold, further tracking movement is stopped and the solar tracking system initiates continuous back movement of the solar panel to keep it ready for the next solar period operation. The steps of tracking are optimized to ensure maximum gain and maximum life of actuating mechanism.

The solar tracking system (100) may be in communication with a SCADA system using a wireless and/or a wired communication. It can communicate parameters like tracking angle, stow position, battery current, battery voltage, tracking mechanism health etc. to any SCADA system.

In an embodiment, solar tracking system (100) is configured in a smart cleaning mode. In this mode, the SCADA system communicates with the processor(s) (102) by sending smart cleaning signals to the processor(s) (102). On receiving the smart cleaning signals, the processor(s) (102) sends command signals to the motor driver(s) (104) to orient the solar panels at angles of 45° and −45° such that the solar panels of the alternate rows are oriented in a V-shaped configuration. Such an orientation facilitates an easy cleaning of the solar panels. In another embodiment, the actuator(s) driven by the motor driver(s) (104) are also provided with a manual switch which facilitates manual orientation of the solar panel(s) in emergency situations.

The solar tracking system (100) is powered by the solar panel. The solar panel acts as a primary power source for the solar tracking system (100). Further, a battery backup (122) is provided as a secondary power source for the solar tracking system which provides power to the solar tracking system (100) to operate independently for 1-5 days. Depending upon the application requirements, the secondary battery backup (122) can also be selected so as to provide a power backup of greater than 5 days. Further, the system also includes a battery management unit (126) communicatively coupled to the battery backup (122) and the processor (102). The battery management unit (126) is configured to control charging and discharging cycles of the battery backup (122) based on the commands received from the processor (102). Further, the battery management unit (126) is further configured to estimate the life of the battery backup (122) based on state of charge (SOC), voltage, and current of the battery backup (122).

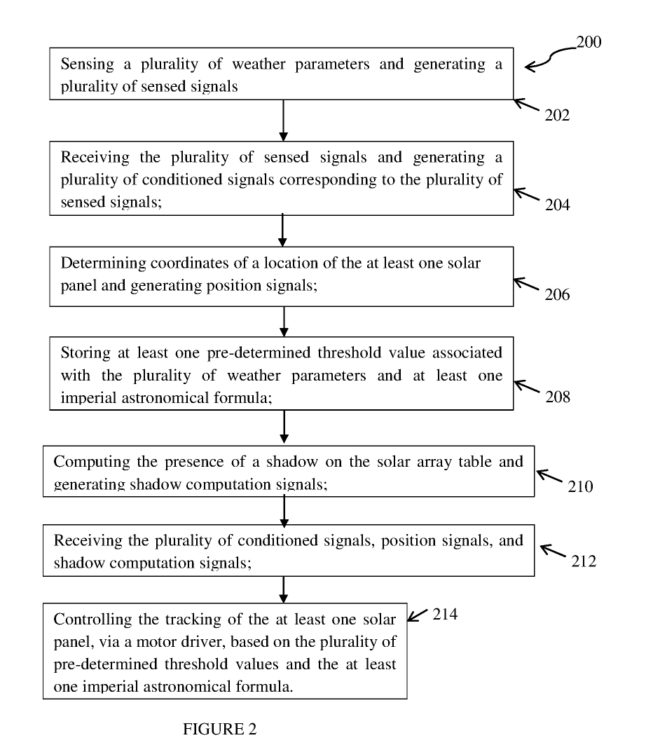

FIG. 2 illustrates a method of controlling drive motors operatively connected to the solar panels. The method (200) may be described in the general context of computer executable instructions. Generally, computer executable instructions can include routines, programs, objects, components, data structures, procedures, units, functions that perform particular functions or implement particular abstract data types. The method (200) may also be practiced in a distributed computing environment where functions are performed by remote processing devices that are linked through a communication network. In a distributed computing environment, computer executable instructions may be located in both local and remote computer storage media, including memory storage devices. Furthermore, the method (200) can be implemented in any suitable hardware, software, firmware, or combination thereof. The firmware may be remotely altered/replaced with a newer version if required.

The order in which the method (200) is described is not intended to be construed as a limitation, and any number of the described method blocks can be combined in any order to implement the method (200) or alternative methods. Additionally, individual blocks may be deleted from the method (200) without departing from the spirit and scope of the subject matter described herein. Furthermore, the method (200) can be implemented in any suitable hardware, software, firmware, or combination thereof.

At block 202, the method (200) includes sensing a plurality of weather parameters and generating a plurality of sensed signals. In an embodiment, the weather information unit (118) includes the plurality of sensors configured to generate sensed signals corresponding to different weather parameters.

At block 204, the method (200) includes receiving the plurality of sensed signals and generating a plurality of conditioned signals corresponding to the plurality of sensed signals. In an embodiment, the weather information unit (118) includes the signal conditioning unit configured to generate conditioned signals corresponding to the aforementioned sensed signals.

At block 206, the method (200) includes determining coordinates of a location of the solar array table and generating position signals. In an embodiment, the GPS unit (116) is configured to determine coordinates of a location of the solar array table and generate position signals.

At block 208, the method (200) includes storing at least one pre-determined threshold value associated with the plurality of weather parameters and at least one imperial astronomical formula and trigonometry. In an embodiment, the repository (112) is configured to store the at least one pre-determined threshold value associated with the plurality of weather parameters and the at least one imperial astronomical formula and trigonometry.

At block 210, the method (200) includes computing the presence of a shadow on the solar array table and generating shadow computation signals. In an embodiment, the shadow computation unit (124) is configured to compute the presence of the shadow using said imperial formula and said feedback signal at every instant of time.

At block 212, the method (200) includes receiving the plurality of conditioned signals, the position signals, and the shadow computation signals. In an embodiment, the processor (102) is configured to receive the plurality of conditioned signals, the position signals, and the shadow computation signals.

At block 214, the method (200) includes controlling the tracking of the at least one solar panel, via a motor driver, based on the plurality of pre-determined threshold values and the at least one imperial astronomical formula and trigonometry. In an embodiment, the controlling is performed by the processor (102).

In an exemplary embodiment, the method (200) further includes the steps of:
selecting a conditioned signal corresponding to an sensed signal generated by a wind sensor;
extracting a wind speed value from the conditioned signal; and
comparing the wind speed value with a pre-determined threshold.

In an embodiment, when it is detected by the processor (102) that the wind speed value is greater than the pre-determined threshold value, the method (200) includes the step of generating and transmitting command signals for orienting the at least one solar panel in an operative horizontal position with respect to the ground or in the safe position, which has been discussed in the previous sections of the present disclosure.

In another embodiment, when it is detected by the processor (102) that the wind speed value is less than the pre-determined threshold value, the method (200) includes the following steps:
receiving at least one co-ordinate signal and at least one global time signal;
calculating solar azimuth and zenith angles of the Sun using the at least one co-ordinate signal and the at least one global time signal based on the at least one imperial astronomical formula and trigonometry; and
generating and transmitting backtracking signals to the motor driver, subsequent to the sunset, for moving the at least one actuator to orient the at least solar panel at an initial position.

The method (200), can optionally include taking a feedback from the actuator and drive motors. In an embodiment, the feedback system (110) takes the feedback from the actuator and drive motors. The feedback system (110) generates and transmits a feedback signal to the processor (102). The feedback signal may include information on whether the duty cycle of the pulses is proper or not. The processor (102) sends the feedback signal to a SCADA (supervisory control and data acquisition) system and the maintenance operator via the internet interface unit (120).

### TECHNICAL ADVANCES AND ECONOMICAL SIGNIFICANCE

The present disclosure described herein above has several technical advantages including, but not limited to, the realization of a solar tracking system and a method thereof which:
is not complex;
is self-powered and requires less maintenance;

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A solar tracking system (100) for automatically controlling the tracking of at least one solar panel in a solar array table, said system comprising:
i. a weather information unit (118) associated with said at least one solar panel, said weather information unit (118) includes:
a. a plurality of sensors configured to sense a plurality of weather parameters and generate a plurality of sensed signals; and
b. a signal conditioning unit configured to receive said plurality of sensed signals and generate a plurality of conditioned signals corresponding to said plurality of sensed signals;
ii. a GPS unit (116) associated with said at least one solar panel, said GPS unit (116) configured to determine coordinates of a location of said at least one solar panel and generate position signals;
iii. a repository (112) configured to store at least one pre-determined threshold value associated with said plurality of weather parameters and at least one imperial astronomical formula and trigonometry;
iv. a motor driver (104) associated with each solar panel in said solar array table, said motor driver configured to drive at least one actuator associated with each solar panel of said solar array table;
v. a shadow computation unit (124) configured to compute the presence of a shadow, using said imperial astronomical formula and trigonometry, on said solar array table and generate shadow computation signals;
vi. a processor (102) communicatively coupled with said weather information unit, said GPS unit, said repository, said motor driver, and said shadow computation unit, said processor configured to receive said plurality of conditioned signals, said position signals, and said shadow computation signals and control the tracking of said at least one solar panel via said motor driver based on said plurality of pre-determined threshold values and said at least one imperial astronomical formula and trigonometry.

2. The system as claimed in claim 1, wherein said plurality of sensors is selected from the group consisting of a wind sensor, a temperature sensor, a pyrometer, a rainfall sensor, a pressure sensor, and a humidity sensor.

3. The system as claimed in claim 1, wherein the type of said plurality of conditioned signals is selected from the group consisting of an analog signal, a digital signal, a mixed signal, a protocol, a frame and a packet.

4. The system as claimed in claim 2, wherein said at least one weather parameter of said plurality of weather parameters is wind speed sensed by said wind sensor.

5. The system as claimed in claim 4, wherein said processor (102) is configured to:
i. select a conditioned signal from said plurality of conditioned signal corresponding to a sensed signal, from said plurality of sensed signals, generated by said wind sensor;
ii. extract a wind speed value from said conditioned signal;
iii. compare said wind speed value with a pre-determined threshold value from said at least one pre-determined threshold value wherein:
a. said processor (102) further configured to generate and transmit command signals to said motor driver for orienting said at least one solar panel in a safe position, when said wind speed value is greater than said pre-determined threshold value; and
b. said processor (102) further configured to:
I. receive at least one position co-ordinate signal and at least one global time signal from said GPS unit;
II. calculate solar azimuth and zenith angles of the Sun using said at least one position co-ordinate signal and said at least one global time signal based on said at least one imperial astronomical formula and trigonometry; and
III. generate and transmit backtracking signals to said motor driver, subsequent to the sunset, for moving said at least one actuator to orient said at least one solar panel at an initial position;
when said wind speed value is less than said pre-determined threshold value.

6. The system as claimed in claim 1, which includes a feedback unit (110) configured to generate and transmit feedback signals pertaining to the movement of said at least one actuator to said processor (102).

7. A solar tracking method (200) for automatically controlling the tracking of at least one solar panel in a solar array table, said method comprising the following steps:
i. sensing a plurality of weather parameters and generating a plurality of sensed signals;
ii. receiving said plurality of sensed signals and generating a plurality of conditioned signals corresponding to said plurality of sensed signals;
iii. determining coordinates of a location of said at least one solar panel and generating position signals;
iv. storing at least one pre-determined threshold value associated with said plurality of weather parameters and at least one imperial astronomical formula and trigonometry;
v. computing the presence of a shadow on said solar array table and generating shadow computation signals;
vi. receiving said plurality of conditioned signals, position signals, and shadow computation signals; and
vii. controlling the tracking of said at least one solar panel, via a motor driver, based on said plurality of pre-determined threshold values and said at least one imperial astronomical formula and trigonometry.

8. The method as claimed in claim 7, which further includes the following steps:
i. selecting a conditioned signal corresponding to a sensed signal generated by a wind sensor;
ii. extracting a wind speed value from said conditioned signal;
iii. comparing said wind speed value with a pre-determined threshold.

9. The method as claimed in claim 7, which further includes the step of generating and transmitting command signals for orienting said at least one solar panel in a safe position when said wind speed value is greater than said pre-determined threshold value.

10. The method as claimed in claim 7, which further includes the following steps:
i. receiving at least one co-ordinate signal and at least one global time signal;
ii. calculating solar azimuth and zenith angles of the Sun using said at least one co-ordinate signal and said at least one global time signal based on said at least one imperial astronomical formula and trigonometry; and
iii. generating and transmitting backtracking signals to said motor driver, subsequent to the sunset, for moving said at least one actuator to orient said at least solar panel at an initial position;
when said wind speed value is less than said pre-determined threshold value.

11. The method as claimed in claim 7, which further includes the step of generating and transmitting feedback signals pertaining to the movement of said actuator.
